(19) United States
(12) Patent Application Publication
(10) Pub. No.: US 2026/0035119 A1
(43) Pub. Date: Feb. 5, 2026

(54) CONTAINER FILLING SYSTEMS AND METHODS

(71) Applicant: GoodFarms, LLC, San Diego, CA (US)

(72) Inventors: Zachary Pascual, Sacramento, CA (US); Charles Johnstone, Davis, CA (US); Cedric Jeanty, Davis, CA (US); Karl Boucher, Elk Grove, CA (US)

(21) Appl. No.: 19/354,793

(22) Filed: Oct. 9, 2025

Related U.S. Application Data
(63) Continuation of application No. PCT/US2024/023605, filed on Apr. 8, 2024.
(60) Provisional application No. 63/495,258, filed on Apr. 10, 2023.

(51) Int. Cl. B65B 57/14; B65B 25/04; B65G 43/08

(52) U.S. Cl. CPC B65B 57/14; B65B 25/046; B65G 43/08; B65G 2201/0211

(57) ABSTRACT

A system for filling containers with loose items can include a container conveyor configured to move containers to a container filling location, an item conveyor having a downstream end disposed above the container conveyor at the container filling location, one or more sensors configured to detect the items moving on the item conveyor, and one or more processors in communication with the container conveyor and the one or more sensors. The one or more processors can be configured with computer-executable instructions to receive signals from the one or more sensors and to control a speed of the container conveyor based on the signals received from the one or more sensors.

### INCORPORATION BY REFERENCE

This application is a continuation of International Application No. PCT/US2024/023605, filed Apr. 8, 2024, which claims the benefit of U.S. Provisional Application Ser. No. 63/495,258, filed Apr. 10, 2023, both of which are hereby incorporated by reference in their entirety.

### FIELD

The present disclosure relates to systems and methods for transferring items into bins or other containers.

### BACKGROUND

Items may be loaded into bins or other containers in a variety of processes. In some cases, the items may be soft, brittle, or otherwise susceptible to structural or cosmetic damage, such as produce (e.g., berries or other fruit, vegetables, and the like). In such cases, the items may need to be placed into bins or containers while reducing the number of “touches” the items receive over the course of the process. It may also be desirable to fill or partially fill containers with a desired weight or volume of items by an automated process. However, such automated filling may be difficult for items such as fruit or other produce which may not have a uniform size or shape.

### SUMMARY

The systems and methods of this disclosure each have several innovative aspects, no single one of which is solely responsible for its desirable attributes. Without limiting the scope as expressed by the claims that follow, its more prominent features will now be discussed briefly.

In a first aspect, a system includes: a container conveyor configured to move containers to a container filling location; an item conveyor configured to move items to the container filling location, the item conveyor having a downstream end disposed above the container conveyor at the container filling location; one or more sensors configured to detect the items moving on the item conveyor; and one or more processors in communication with the container conveyor and the one or more sensors, the one or more processors configured with computer-executable instructions to at least: receive signals from the one or more sensors; and control a speed of the container conveyor based on the signals received from the one or more sensors.

In some embodiments, the container conveyor includes a container supply conveyor and a container fill conveyor.

In some embodiments, the container fill conveyor receives the containers from the container supply conveyor and moves the containers to the container filling location.

In some embodiments, the container fill conveyor includes one or more drive belts configured to grip the containers received from the container supply conveyor.

In some embodiments, the container supply conveyor carries containers from an upstream location to the container fill conveyor.

In some embodiments, the container supply conveyor continuously carries containers to the container fill conveyor such that the containers accumulate at a location proximate the container fill conveyor.

In some embodiments, the speed controlled by the one or more processors is a speed of the container fill conveyor.

In some embodiments, the one or more processors are further configured to maintain a speed of the container supply conveyor constant while adjusting the speed of the container fill conveyor.

In some embodiments, the container conveyor includes at least two side belts configured to laterally grip the containers on opposing sides of the container.

In some embodiments, each of the at least two side belts are configured to move at a same speed.

In some embodiments, the container conveyor further includes at least one bottom belt configured to contact bottom sides of the containers.

In some embodiments, each of the at least one bottom belts are configured to move at the same speed as the at least two side belts.

In some embodiments, the container conveyor includes a left module including a first one of the at least two side belts and a right module including a second one of the at least two side belts.

In some embodiments, the system further includes at least one lateral movement device, the lateral movement device configured to adjust a distance between the left module and the right module.

In some embodiments, the one or more processors are further configured to determine, based on the received signals from the one or more sensors, a volume flux of items moving on the item conveyor.

In some embodiments, the one or more processors are further configured to calculate an updated volume flux based on the received signals from the one or more sensors.

In some embodiments, the one or more processors are further configured to increase the speed of the container conveyor in response to an increase in the updated volume flux and to decrease the speed of the container conveyor in response to a decrease in the updated volume flux.

In some embodiments, the item conveyor is disposed such that the items fall off the downstream end of the item conveyor upon arriving at the container filling location.

In some embodiments, the system further includes a guide at the container filling location, the guide including at least one wall positioned to guide the items falling from the downstream end of the item conveyor into the containers on the container conveyor.

In some embodiments, the one or more processors are configured to control the speed of the container conveyor such that each of the containers are filled with a predetermined volume of items.

In some embodiments, the one or more sensors includes at least one optical sensor, at least one two dimensional camera, or at least one three dimensional camera.

In some embodiments, the items are strawberries.

In a second aspect, a computer-implemented method of filling containers with items includes: moving containers on a container conveyor to a container filling location; moving items on an item conveyor to the container filling location, wherein the items fall off a downstream end of the item conveyor disposed above the container conveyor at the container filling location; determining, based on signals received from one or more sensors disposed proximate the item conveyor, a characteristic of the items while the items are on the item conveyor; adjusting a speed of the container conveyor at the container filling location based on the determined characteristic of the items; and moving the containers, via the container conveyor, to a location downstream of the container filling location.

In some embodiments, the container conveyor includes: a container fill conveyor configured to move the containers through the container filling location; and a container supply conveyor upstream of the container fill conveyor and configured to provide the containers to the container fill conveyor.

In some embodiments, adjusting the speed of the container conveyor includes: adjusting the speed of the container fill conveyor as a function of the characteristic measured by the one or more sensors such that each container is filled with a predetermined volume of items; and maintaining the speed of the container supply conveyor constant.

In some embodiments, the determined characteristic of the moving items includes a volume flux of the items on the item conveyor.

In some embodiments, the method further includes: calculating an updated volume flux based on the received signals; and adjusting the speed of the container conveyor based on the updated volume flux.

In some embodiments, adjusting the speed of the container conveyor includes increasing the speed of the container conveyor in response to an increase in the updated volume flux or decreasing the speed of the container conveyor in response to a decrease in the updated volume flux.

In some embodiments, the items are strawberries.

### BRIEF DESCRIPTION OF THE DRAWINGS

The above-mentioned aspects, as well as other features, aspects, and advantages of embodiments of the present disclosure will now be described in connection with various implementations, with reference to the accompanying drawings. The illustrated implementations are merely examples and are not intended to be limiting. Throughout the drawings, similar symbols typically identify similar components, unless context dictates otherwise.

FIG. 1 is a top front isometric view of an example system for filling containers with loose items in accordance with the present disclosure.

FIG. 2 depicts a side view of the example system of FIG. 1.

FIGS. 3A-3B depict side views of portions of the example system of FIGS. 1 and 2.

FIG. 4 depicts a front isometric view of the example system of FIGS. 1-3B.

FIG. 5 depicts a cutaway view of the example system of FIGS. 1-4.

FIG. 6 depicts a top view of the example system of FIGS. 1-5.

FIG. 7 shows a front isometric view of a portion of a system for filling containers with loose items in accordance with the present disclosure.

FIG. 8 shows a rear view of a portion of the system of FIG. 7.

FIG. 9 shows a side view of a portion of the system of FIGS. 7-8.

FIG. 10 shows a top view of a portion of the system of FIGS. 7-9.

FIG. 11 shows a front isometric view of a portion of a system for filling containers with loose items, where the system has one processing lane.

FIG. 12 shows a rear view of a portion of the system of FIG. 11.

FIG. 13 shows a top view of a portion of the system of FIGS. 11-12.

FIG. 14 is a schematic illustration of an example item processing system including a container filling system in accordance with the present disclosure.

FIG. 15 is a block diagram of an example container filling system in accordance with the present disclosure.

FIG. 16 is a flowchart illustrating an example method for filling containers in accordance with the present disclosure.

### DETAILED DESCRIPTION

Embodiments of the present disclosure provide systems and methods capable of filling bins or other containers with loose items within a partially or fully automated process such as for transportation, processing, or packaging of items. Throughout the following description, various embodiments will be described with reference to the example implementation of binning and/or processing agricultural crops such as strawberries. However, it will be understood that any of the systems, devices, or methods described herein may equally be applied to any other industrial, agricultural, or other application, for example, handling, transporting, loading, unloading, and/or processing of other crops, eggs or other delicate items, or the like.

Items may be transported in containers, such as bins or other open or closed containers. For example, in manual or autonomous harvesting of crops, items such as berries (e.g., strawberries or other berries), apples, or any other fruit or vegetable crop may be picked and placed into a bin or other container for transportation from the location where the items are grown (e.g., a field, orchard, etc.) to a secondary location (e.g., a processing, shipping, or transport facility) where the items are packed into smaller or different containers or otherwise processed. For example, in the non-limiting example implementation of strawberry harvesting, strawberries may be transported in open bins from a field where the strawberries are grown to a processing facility such as a pack line where they are removed from the bins and placed into smaller containers such as clamshells for transportation to retailers, consumers, or other strawberry processing entities.

Transferring items from a processing system to a bin or other small packaging container can be done manually. Manually transferring items can be imprecise and time-consuming, especially when the items being transferred are delicate, breakable, or susceptible to cosmetic damage such as bruises or other blemishes on the skin of a fruit or vegetable item. Items may be dropped and damaged during a manual transfer, causing waste and reduced yield from harvesting of crops. In addition, manual transfer involves cost-intensive and highly variable labor sources, as well as additional supervisory resources to ensure quality control.

Automated transfer of items into containers may therefore be desirable. However, in implementations such as packing of produce or the like, it may be difficult to reliably fill containers to a desired level (e.g., a predetermined weight, volume, number of items, or other quantity measure) due to variations in the size, weight, shape, and/or dimensions of individual items. Advantageously, embodiments of the present disclosure provide for rapid, efficient automated transfer of items from a conveyor or other processing structure to a packaging container, while providing for reliable filling to a predetermined level.

As will be described in greater detail, some embodiments of the present disclosure include a container conveyor transporting a continuous line of empty containers (e.g., clamshells or other containers) to a container filling location, as well as an item conveyor transporting a continuous flow of items (e.g., strawberries or other produce) to the container filling location above the empty containers. At least a portion of the container conveyor (e.g., a container fill conveyor) has an adjustable speed controllable by processing circuitry that simultaneously calculates a rate at which items are arriving at the container filling location (e.g., a volume flux of arriving strawberries calculated based on signals received from optical sensors located near the item conveyor). The processing circuitry can accordingly control the fill level of each container by adjusting the speed of the containers passing through the container filling location. For example, the processing circuitry can increase the speed of the container fill conveyor in response to an increase in the volume flux of arriving items, such that the next container spends less time in the container filling location. Similarly, the processing circuitry can decrease the speed of the container fill conveyor in response to a decrease in the volume flux of arriving items, such that the next container spends more time in the container filling location. The disclosed systems and methods can thereby precisely control the container filling without having to speed up or slow down the item conveyor, which may undesirably affect upstream operations in an item processing line.

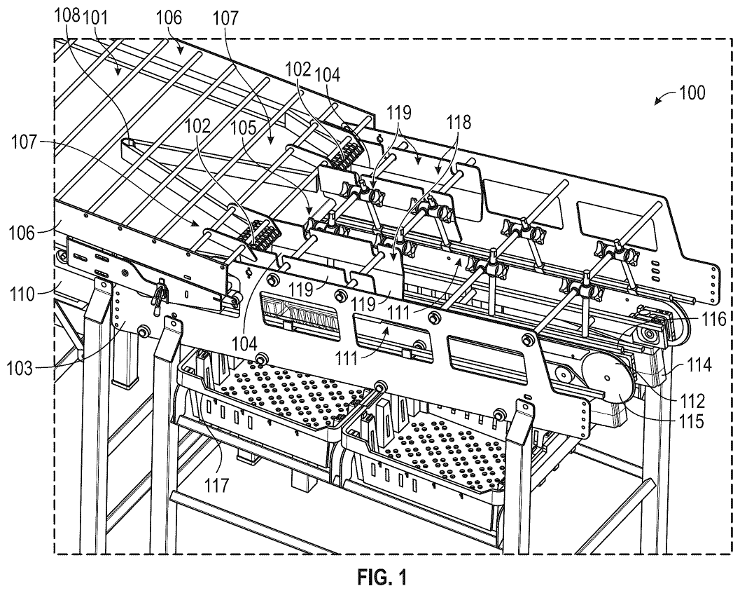

FIG. 1 depicts an example embodiment of a system 100 for transferring items to containers from a pack line. The system 100 may include an item conveyor 101, at least one sensor 102 and at least one container conveyor 103. As seen in FIG. 1, the item conveyor 101 is configured to transport items from a location upstream to a container filling location 104. In some embodiments, the item conveyor 101 may be configured such that the items fall off a first end 105 of the item conveyor 101 when the items arrive at the container filling location 104.

The item conveyor 101 may include side walls 106 to prevent items traveling on the item conveyor 101 from falling off the sides of the item conveyor 101. In some embodiments, the item conveyor 101 may include multiple item processing lanes 107. For example, in the non-limiting embodiment illustrated in FIG. 1, the item conveyor 101 includes two item processing lanes 107. In embodiments including more than one item processing lanes 107, the item conveyor 101 may include an item divider 108 configured to direct the flow of items traveling on the item conveyor 101 to the item processing lanes 107. In some embodiments, the item divider 108 may include two prongs configured to direct the flow of items to the two processing lanes of the item conveyor 101, wherein each prong directs the flow of items to a different processing lane.

As seen in FIG. 1, the at least one sensor 102 is positioned above the item conveyor 101. In various embodiments, the at least one sensor 102 can be positioned above, below, or to the side of the at least one item processing lane 107. Where multiple item processing lanes 107 are present, there may be at least one sensor 102 provided for each item processing lane 107. In some implementations, there may be a plurality of sensors 102 provided for each item processing lane 107. For example, there may be two, three, four, five, or more sensors (e.g., eight sensors 102 as illustrated in FIG. 1). The number of sensors 102 in each item processing lane 107 may be selected, for example, based on a desired detection resolution and/or based on a number of sensors that can fit within the width of the item processing lane 107. In some embodiments, the sensors 102 can include one or more two dimensional or three dimensional cameras.

The sensors 102 can detect items or can measure one or more characteristics of the items traveling on the item conveyor 101. In some embodiments, the sensors 102 may project light such as a laser beam or the like onto the item conveyor 101. In some embodiments, the at least one sensor 102 may measure a characteristic of the items traveling on the item conveyor 101 when the items traveling on the item conveyor 101 break the at least one laser projected onto the item conveyor 101. In some embodiments, the sensors 102 are in communication with processing circuitry configured to determine a volume flux of the items traveling on the item conveyor 101. In some embodiments, each sensor 102 is configured to periodically transmit a signal which can indicate to the processing circuitry whether the emitted light beam is contacting the conveyor 101 or is being broken by an item disposed between the sensor 102 and the item conveyor 101.

As seen in FIG. 1, the at least one container conveyor 103 is configured to transport containers from a location upstream to a container filling location 104. In some embodiments, the at least one container conveyor 103 is further configured to transport containers from the container filling location 104 to a location downstream of the processing line. As seen in FIG. 1, the at least one container conveyor 103 may be positioned beneath the item conveyor 101 such that the containers being transported by the at least one container conveyor 103 catch the items that are falling off the item conveyor 101 at the container filling location 104. In some embodiments, the containers being transported are clamshell containers. In some embodiments, the item conveyor may be adjustable to account for containers of various sizes. In some embodiments, containers may be continuously transported by the at least one container conveyor 103 such that a next container is continuously available at the container filling location 104 while items are being transported by the item conveyor 101.

In some embodiments, the at least one container conveyor 103 may include a container supply conveyor 110 and a container fill conveyor 111. In some embodiments, the at least one container conveyor 103 may include individual container supply conveyors 110 and container fill conveyors 111 for the individual item processing lanes 107. The container supply conveyor 110 may be configured to transport containers from a location upstream to the container fill conveyor 111.

The container fill conveyor 111 may be configured to transport containers from the container supply conveyor 110 to the container filling location 104. In some embodiments, the container fill conveyor 111 is further configured to transport containers from the container filling location 104 to a location downstream. In some embodiments, the container fill conveyor 111 may include a belt 112 configured to engage with the containers. The belt 112 may extend from a first end of the container fill conveyor 111 proximate the container supply conveyor 110 to a second end 114 of the container fill conveyor 111 downstream of the container filling location 104.

In some embodiments, the belt 112 is connected to at least one gear 115. The at least one gear 115 is configured to rotate under control of processing circuitry of the system 100, thereby causing the belt 112 to move containers in contact with the belt 112 from the first end of the container fill conveyor 111 toward the second end 114 of the container fill conveyor 111.

In some embodiments, the container fill conveyor 111 further includes a pressure plate 116. The pressure plate 116 may be located directly above the belt 112. In some embodiments, the pressure plate 116 is configured to exert a pressure on a container being transported by the container fill conveyor 111 such that the container is pressed against the belt 112. In some embodiments, the pressure plate 116 is made of a material with a low coefficient of friction (e.g., a coefficient of friction lower than the coefficient of friction of the belt 112) such that the containers being transported by the container fill conveyor 111 can slide along the surface of the pressure plate 116 without catching or getting stuck on the surface of the pressure plate 116. In some embodiments, the pressure plate 116 may exert a pressure on a container being transported by the container fill conveyor 111 such that the friction between the container and the belt 112 is increased.

Processing circuitry of the system 100 is in communication with the at least one sensor 102 and the gear 115. The processing circuitry is configured to receive signals from the at least one sensor 102 and to control a rotational speed of the at least one gear 115. In some embodiments, the processing circuitry is configured to control a speed of the container fill conveyor 111 based on the signal received from the at least one sensor 102. For example, the processing circuitry may be configured to control a speed of the container fill conveyor 111 based on the signal received from the at least one sensor 102 such that the containers being transported by the at least one container conveyor 103 are each filled with approximately the same volume, weight, or number of items.

In some embodiments, the system 100 may further include a plurality of overflow receiving containers 117. The overflow receiving containers 117 may be positioned underneath the at least one container conveyor 103 at a location near the container filling location 104, for example, to catch any items that do not fall into containers being transported by at the container conveyor 103 or that bounce or fall out of the containers. In some embodiments, the overflow receiving containers 117 may be significantly larger than the containers being transported by the container conveyor 103. In some embodiments, the overflow receiving containers 117 are positioned beneath the at least one container conveyor 103 such that the plurality of overflow receiving containers 117 extends along the breadth and width of the container fill conveyor 111. Such a configuration may be beneficial for catching items that fall out of the containers being transported by the container fill conveyor 111.

In some embodiments, the system 100 further includes one or more guides 118. In some embodiments, the guides 118 are composed of a metal or polymer. In some embodiments, the guides 118 are composed of stainless steel. The guides 118 may be positioned at the first end 105 of the item conveyor 101. In some embodiments, the guides 118 are configured to direct items that fall off the first end 105 of the item conveyor 101 into the containers being transported by the container conveyor 103. In some embodiments, the number of guides 118 may be equal to the number of item processing lanes 107 of the item conveyor 101 (e.g., a guide 118 may be provided for each item processing lane 107). As seen in FIG. 1, each guide 118 may include walls 119. The walls 119 may be positioned on either side of the at least one item processing lane 107 of the item conveyor 101. In some embodiments, the guides 118 may be at least partially funnel-shaped, such that the distance between lower portions of the plurality of walls 119 is smaller than a width of the containers being filled. Such a configuration may be beneficial for reducing the number of items that fall outside the containers and into the overflow receiving containers 117.

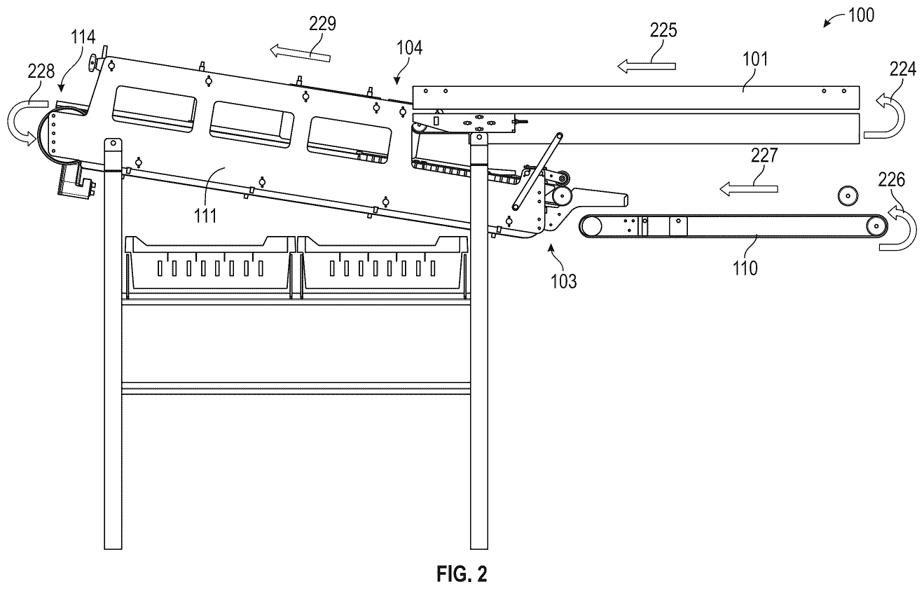

FIG. 2 depicts a side view of the system 100, illustrating axes of motion of several components thereof. As shown in FIG. 2, the container fill conveyor 111 may be orientated at an angle relative to horizontal such that an upstream end 114 of the container fill conveyor 111 is lower relative to a downstream end of the container fill conveyor 111. In some embodiments, the angle may be between 0° and 45° relative to horizontal. Such a configuration may be beneficial for allowing items that do not settle within one container (e.g., items falling into an overfilled container, bouncing out of a container, or landing on the sidewalls of two adjacent containers in a line of containers being filled) to fall backwards into another container in the line rather than falling out of the system 100.

As seen in FIG. 2, the item conveyor 101 is configured to rotate in a direction 224 such that the items being transported by the item conveyor 101 move in a direction 225 toward the container filling location 104. The container supply conveyor 110 is configured to rotate in a direction 226 such that containers being transported by the container supply conveyor 110 move in a direction 227 toward the container filling location 104 where the items from the item conveyor 101 can fall into the containers. The container fill conveyor 111 is configured to rotate in a direction 228 such that containers being transported by the container fill conveyor 111 move in a direction 229 towards the upstream end 114 of the container fill conveyor 111.

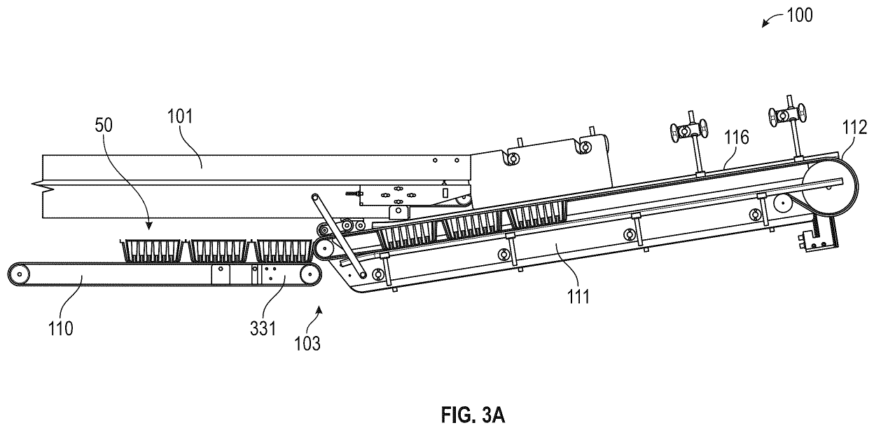

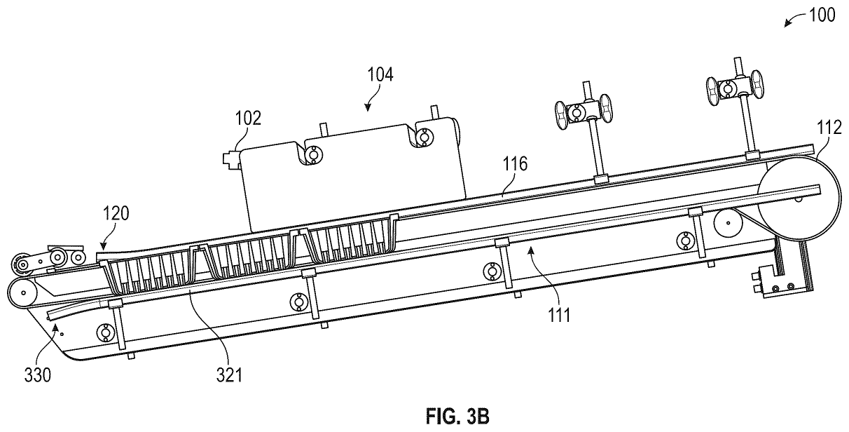

FIGS. 3A-3B depict side views of portions of the system 100, with some components removed to illustrate components of the container conveyor 103 including the container supply conveyor 110 and the container fill conveyor 111. As seen in FIGS. 3A-3B, the pressure plate 116 of the container fill conveyor 111 may extend along and parallel to at least a portion of the belt 112. For example, as illustrated, the pressure plate 116 may extend along all or substantially all of the linear portion of the path of the belt 112. In some embodiments, the pressure plate 116 of the container fill conveyor 111 does not extend the full length of the linear portion of the belt 112, but may extend along at least a portion of the belt 112 underlying the container filling location 104.

As seen in FIG. 3A, the container supply conveyor 310 may be configured to transport containers 50 to the container fill conveyor 111. In some embodiments, the container supply conveyor 110 may be configured to move continuously and independently of the movement of the container fill conveyor 111 such that the containers 50 accumulate at a location 331 near the upstream end of the container fill conveyor 111. Such a configuration may be beneficial for providing a continuous stream of containers 50 to the container fill conveyor 111. In some embodiments, the container supply conveyor 110 may be configured to stop when a container being transported by the container supply conveyor 110 collides with another container on the container supply conveyor 110 or on the container fill conveyor 111, or may be configured to stop when an upstream end of accumulated containers 50 on the container supply conveyor 110 reaches a threshold distance along the container supply conveyor 110.

As seen in FIG. 3B, an upstream end 120 of the pressure plate 316 may be slightly raised or spaced away from the belt 112. This configuration may be beneficial for allowing the containers 50 being transported by the container fill conveyor 111 to slide underneath the pressure plate 116 at the upstream end 120 of the pressure plate 116 without striking the end of the pressure plate 116. The pressure plate 116 is positioned directly above the belt 112 such that the pressure plate 116 exerts a downward force on the containers 50, increasing the normal force between the belt 112 and the containers 50 such that the speed of the containers 50 can be positively controlled by the speed of the belt 112.

As seen in FIG. 3B, the container fill conveyor 111 may further include one or more supports 321. The supports 321 may be connected to the container fill conveyor 111 such that the supports 321 support the bottoms of the containers 50 being transported by the container fill conveyor 111. The supports 321 may be positioned such that that the bottoms of the containers 50 are approximately parallel to the direction of travel along the item fill conveyor 111. In some embodiments, the supports 321 can be composed of a material with a low coefficient of friction (e.g., the same material as the pressure plate 116 or a different low-friction material) such that containers 50 being transported by the container fill conveyor 111 are able to pass along the plurality of supports 321 without catching or becoming stuck. As seen in FIG. 3B, a first end 330 of the supports 321 may be slightly lowered. This configuration may advantageously allow the containers 50 to slide onto the supports 321 at the first end 330 without striking an end of a support 321.

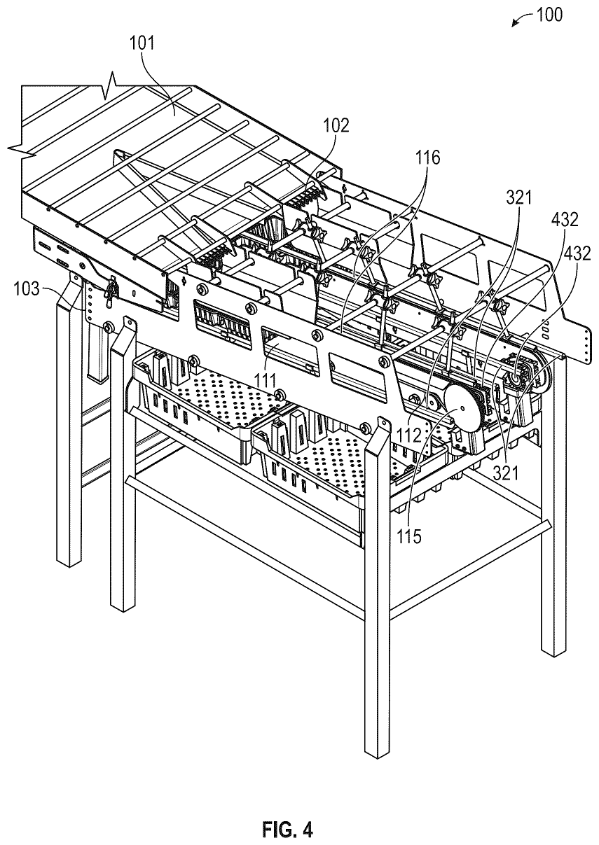

FIG. 4 depicts a perspective view of the system 100. FIG. 4 further illustrates the configuration of the container fill conveyor 111, including the belts 112, gears 115, and pressure plates 116. As seen in FIG. 4, the gears 115 are configured to rotate, causing the belt 112 to move along the length of the container fill conveyor 111. The container fill conveyor 111 can further include motors 432 connected to the gears 115, the motors 432 configured to cause gears 115 to rotate. Each motor 432 may be independently controllable such that the speed of the containers moving along each container fill conveyor 111 can be independent of the speed of each other container fill conveyor 111, for example, depending on the volume flux of items as detected by each group of sensors 102.

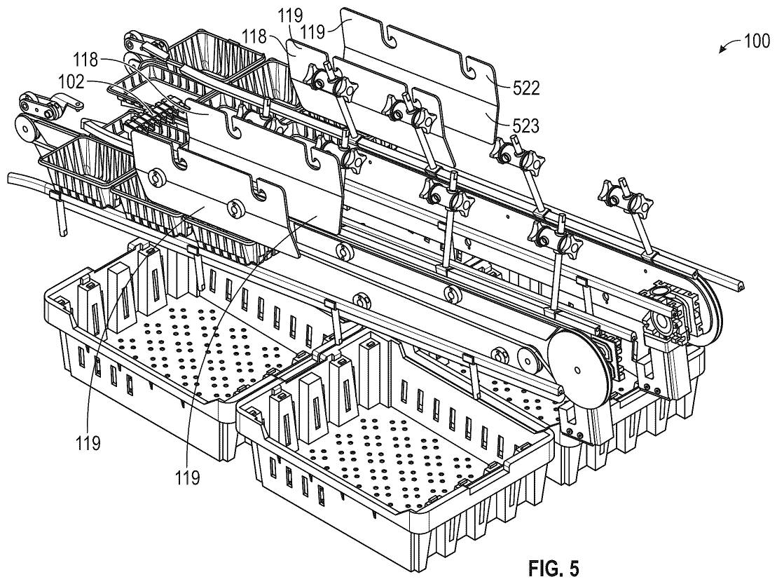

FIG. 5 is a further cutaway view of the system 100, illustrating the configuration of the guides 118 relative to other components of the system 100. As seen in FIG. 5, each guide 118 may include a plurality of walls 119 disposed on opposing lateral sides of the container filling location. A top portion 522 of each wall may be substantially vertical and may extend higher than a height at which the items arrive from the item transport conveyor (e.g., in the configuration illustrated in FIG. 5, the top portion 522 extends to roughly the height of the sensors 102). A bottom portion 523 of one or both walls may be angled inward such that the distance between the walls 119 of each line is narrower than the distance between the walls 119 at the top portion 522. Accordingly, items falling off of the item conveyor may be funneled into the containers being transported by the container conveyor. Advantageously, in some embodiments, the distance between the bottom portions 523 of the walls 119 may narrow to a width smaller than the width of the containers to prevent items from falling over the sides of the containers as the containers are filled.

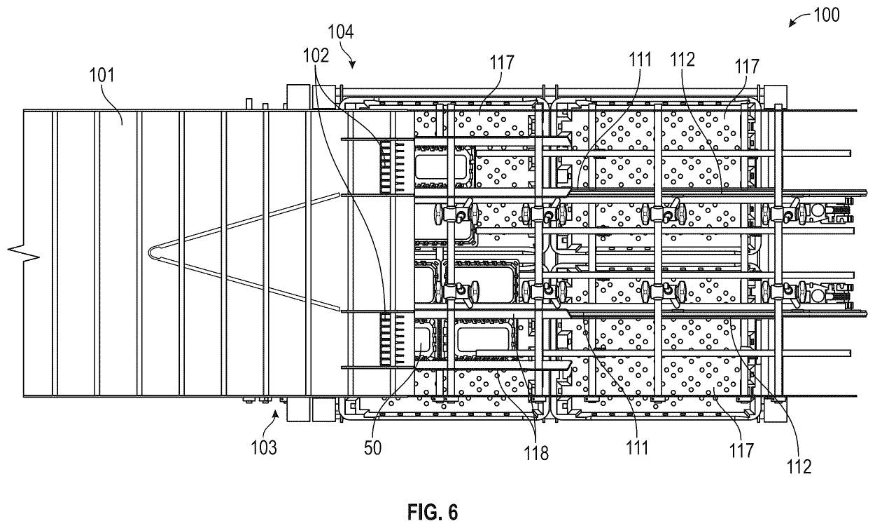

FIG. 6 is a top view of the system 100. As shown in FIG. 6, the container fill conveyor 111 transports lines of containers 50 under container filling locations 104 such that items fall from the item conveyor 101 into the containers 50 as they travel under the container filling locations 104. The speed of each individual line of containers 50 can be controlled by controlling the speed of the belt 112 of each container fill conveyor 111, for example, based on the amount or number of items (e.g., a number, area, volume flux, or other characteristic) detected based on the signals received from the sensors 102. Guides 118 are disposed on opposing sides of each container filling location 104 to guide the items from the item conveyor 101 into the containers 50 and to reduce the frequency with which items fall outside of the containers 50. In the event some items do fall outside the containers 50, trays 117 are disposed below the container fill conveyors 111 and have a larger lateral extent as shown in FIG. 6, so as to catch any items that may fall out. Items collected in the trays 117 may be removed and can be discarded or can be placed back onto the item conveyor 101 to be transferred again into a container 50.

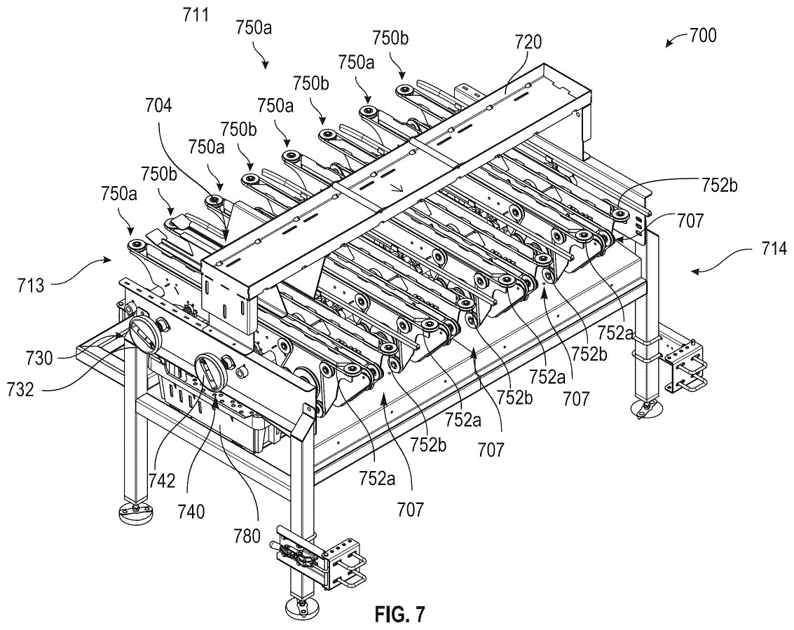

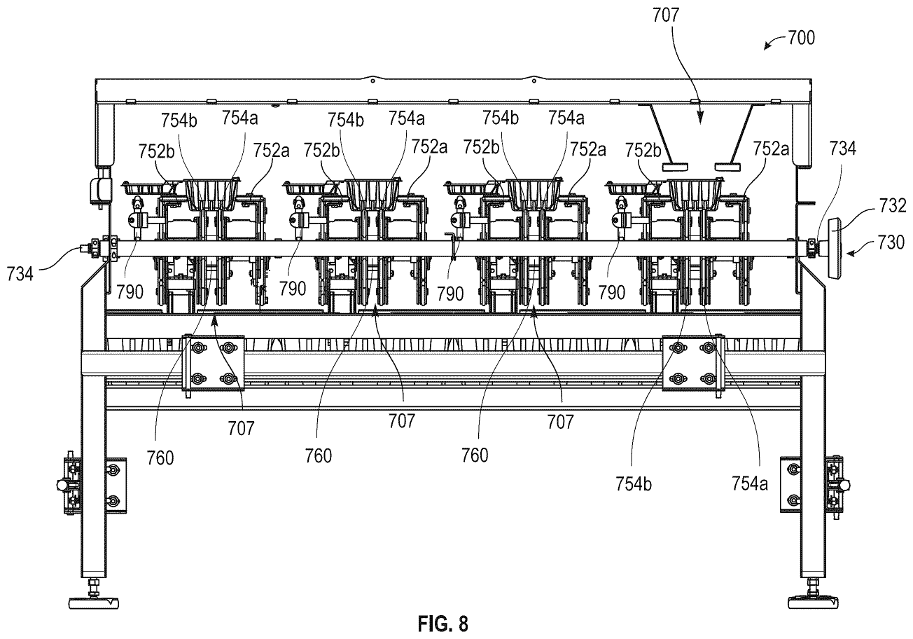

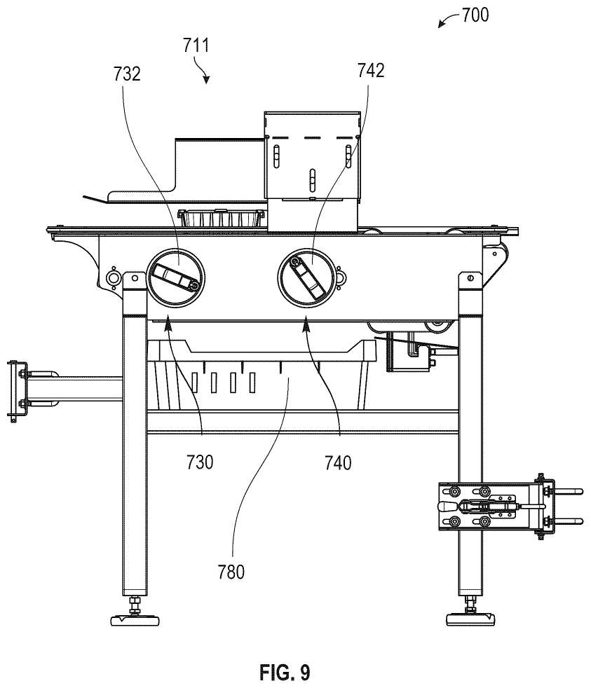

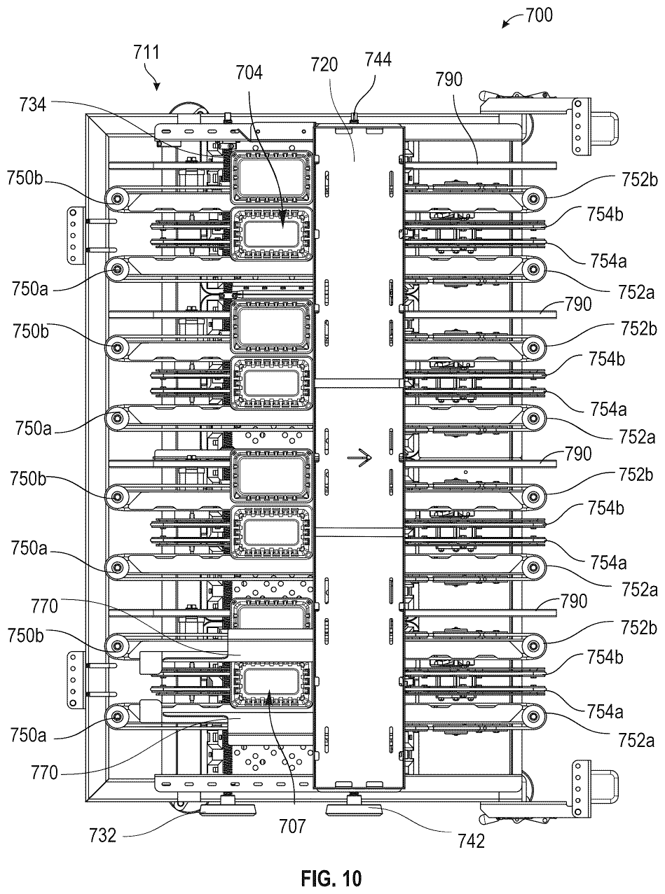

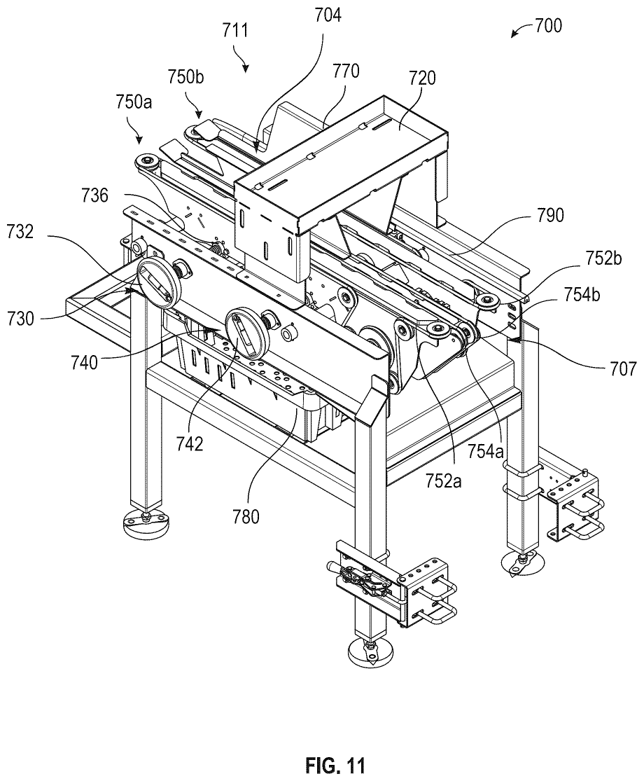

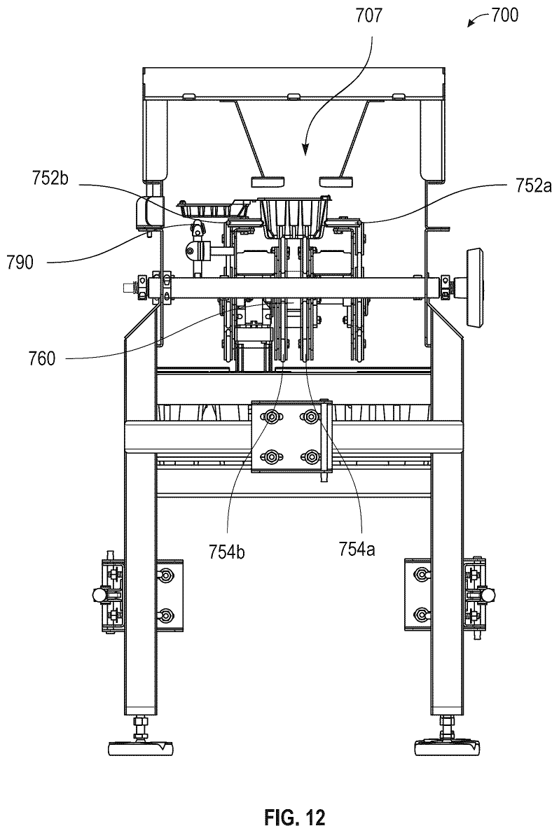

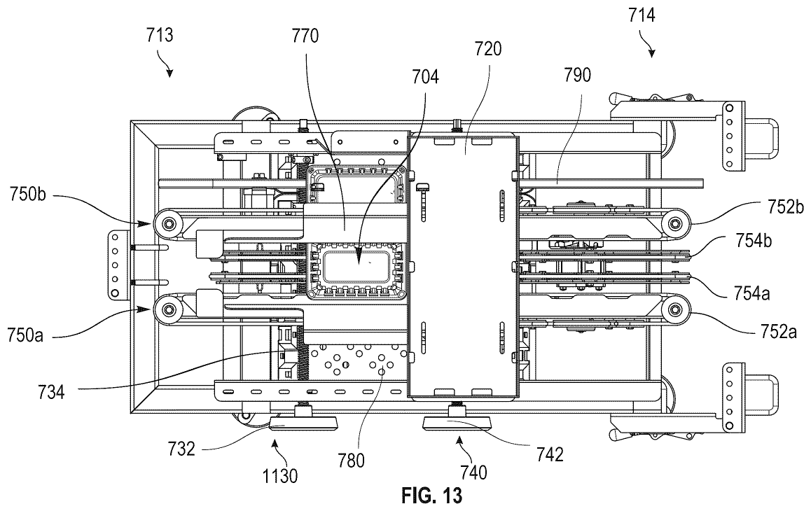

FIGS. 7-10 show various views of a portion of a system 700 for transferring items to containers from a pack line. FIG. 7 shows a front isometric view of a portion of the system 700. FIG. 8 shows a rear view of a portion of the system 700. FIG. 9 shows a side view of a portion of the system 700. FIG. 10 shows a top view of a portion of the system 700. FIGS. 11-13 show various views of a single processing lane 707 of the system 700, or of an implementation in which the system 700 includes only one processing lane 707. FIG. 11 shows a front isometric view of a portion of the system 700 with one processing lane 707. FIG. 12 shows a rear view of a portion of the system 700 with one processing lane. FIG. 13 shows a top view of a portion of a system 700 with one processing lane.

Various elements of the system 700 may be implemented in conjunction with the system 100 described above. The system 700 includes a container fill conveyor 711, an overhead stop 720, a first lateral movement device 730 and a second lateral movement device 740. While not shown in FIG. 7, the system 700 may include features of the system 100 such as an item conveyor, at least one sensor, and a container supply conveyor as described above. The container fill conveyor 711 may be similar or identical in many respects to the container fill conveyor 111 as described above. The container fill conveyor 711 may be configured to interact with an item conveyor, at least one sensor, and a container supply conveyor as described above.

The container fill conveyor 711 may be configured to transport containers from a container supply conveyor (such as the container supply conveyor 110 as described above) to a container filling location 704. In some embodiments, the container fill conveyor 711 is further configured to transport containers from the container filling location 704 to a location downstream.

As seen in FIG. 7, the container fill conveyor 711 may include four processing lanes 707. In some embodiments, the container fill conveyor 711 includes more than four processing lanes 707. In some embodiments, the container fill conveyor 711 includes less than four processing lines 707 including one processing lane (as seen in FIGS. 11-13), two processing lanes, or three processing lanes. Each processing lane 707 may include a left module 750a and a right module 750b, at least one motor 760, a guide 770, an overflow receiving container 780 and a support 790.

In some embodiments, the left and right module 750a and 750b may be similar or identical in many respects. In some embodiments, the left and right module 750a and 750b are mirror images of each other. Each module 750a and 750b may include at least one drive belt. In some embodiments, the drive belt may be a belt or an elastomeric band. In some embodiments, the drive belt of each module 750a and 750b may be a loop passing around a drive motor axis.

In some embodiments, the drive belt of the left module 750a includes at least one side belt 752a and the drive belt of the right module 750b includes at least one side belt 752b. The side belt 752a of the left module 750a and the side belt 752b of the right module 750b are configured to work together to move a container on the container fill conveyor 711. In some embodiments, the side belt 752a of the left module 750a and the side belt 752b of the right module 750b move in parallel to move a container on the container fill conveyor 711 from a first end 713 of the container fill conveyor 711 to a second end 714 of the container fill conveyor 711. In some embodiments, the side belt 752a of the left module 750a and the side belt 752b of the right module 750b move at substantially the same speed when moving a container on the container fill conveyor 711.

The side belts 752a and 752b of each module 750a and 750b are configured to contact a container, such as a clam shell container, an open-top container, or any other suitable container, on opposite sides of the container. In some embodiments, the side belts 752a and 752b contact the container on a left side and on a right side of the container. In some embodiments, the side belt 752a of the left module 750a contacts the left side of the container, while the side belt 752b of the right module 750b contacts the right side of the container. Each side belt 752a and 752b may extend from a first end 713 of the container fill conveyor 711 proximate a container supply conveyor to a second end 714 of the container fill conveyor 711 downstream of the container filling location 704.

The side belts 752a and 752b of the left and right module 750a and 750b are connected to the motor 760 and are configured to rotate under control of processing circuitry of the system 700, thereby causing the side belts 752a and 752b to move containers in contact with the side belts 752a and 52b from the first end 713 of the container fill conveyor 711 toward the second end 714 of the container fill conveyor 711. In some embodiments, each side belt 752a and 752b is connected to the motor 760 in such a way that the speed of each side belt 752a and 752b is equal, thereby allowing the container to maintain a consistent orientation while being moved. In some embodiments, the side belts 752a and 752b of the left and right module 750a and 750b are sufficient to move a container from a first end 713 of the container fill conveyor 711 to the second end 714 of the container fill conveyor 711 without any additional belts.

As seen in FIG. 8, in some embodiments, each of the left and right modules 750a and 750b include at least one bottom belt 754a and 754b to supplement the side belts 752a and 752b. In some embodiments, each of the left module and right module 750a and 750b include one bottom belt 754a and 754b, respectively. Each bottom belt 754a, 754b is configured to contact a container, such as a claim shell container, on a bottom side of the container. The bottom belts 754a and 754b may extend from a first end 713 of the container fill conveyor 711 proximate a container supply conveyor to a second end 714 of the container fill conveyor 711 downstream of the container filling location 704.

Each bottom belt 754a and 754b is connected to the motor 760 and is configured to rotate under control of processing circuitry of the system 700, thereby causing the bottom belts 754a and 754b to move containers in contact with the bottom belts 754a and 754b from the first end 713 of the container fill conveyor 711 toward the second end 714 of the container fill conveyor 711. In some embodiments, each bottom belt 754a and 754b is connected to the motor 760 in such a way that the speed of each bottom belt 754a and 754b is equal, thereby allowing the container to maintain a certain orientation while being moved. Similarly, in some embodiments, each bottom belt 754a and 754b and side belt 752a and 752b is connected to the motor 760 in such a way that the speed of each bottom belt 754a and 754b and side belt 752a and 752b is substantially equal.

In some embodiments, the bottom belts 754a and 754b may serve to assist the side belts 752a and 752b with the movement of a container during at least a portion of the movement of the container along the container fill conveyor 711. In some embodiments, when an empty container begins moving at a first end 713 of the container fill conveyor 711, the container does not contact the bottom belts 754a and 754b, for example, due to a relatively light weight of the empty container. As a container is moved from a first end 713 of the container fill conveyor 711 to the second end 714 of the container fill conveyor 711, the container is filled with items at the item filling location 704. In some embodiments, the weight of items may cause the container to sink lower between the side belts 752a and 752b until a bottom portion or surface of the container contacts the bottom belts 754a and 754b. Once the container contacts the bottom belts 754a and 754b, the movement of the bottom belts 754a and 754b assists the side belts 752a and 752b to move the container towards the second end 714 of the container fill conveyor 711. This configuration may be beneficial where the addition of items to the container causes additional strain on the side belts 752a and 752b and therefore the motor 760. The addition of bottom belts 754a and 754b is beneficial for alleviating some of the additional stress on the side belts 752a and 752b. Moreover, the additional friction or grip provided by the contact of the bottom belts 754a and 754b may further increase the ability to positively control the speed of the container along the container fill conveyor 711 when the speed is being controlled and/or adjusted in order to control the volume, weight, or number of items being loaded into the individual container.

As seen in FIG. 8, each processing lane 707 includes at least one motor 760. In some embodiments, each processing lane 707 includes one motor 760. In some embodiments, each processing includes more than one motor 760. In some embodiments, the left and right module 750a and 750b may each have a separate motor 760. In some embodiments, the motor 760 may be located in between the left module 750a and the right module 750b of the processing line 707. The motor 760 is in mechanical communication with the side belts 752a and 752b and/or the bottom belts 754a and 754b of the left and right modules 750a and 750b. In some embodiments, the motor 760 is in mechanical communication with the side belts 752a and 752b and/or the bottom belts 754a and 754b by means of one or a plurality of gears.

Processing circuitry of the system 700 is in communication with the at least one sensor and the motor 760. The processing circuitry is configured to receive signals from the at least one sensor and to control a rotational speed of the side belts 752a and 752b and/or bottom belts 754a and 754b by means of the motor 760. In some embodiments, the processing circuitry is configured to control a speed of the side belts 752a and 752b of the left and right modules 750a and 750b based on the signal received from the at least one sensor. In some embodiments, the processing circuitry is further configured to control a speed of the bottom belts 754a and 754b of the left and right modules 750a and 750b based on the signal received from the at least one sensor. For example, the processing circuitry may be configured to control a speed of the side belts 752a and 752b and/or the bottom belts 754a and 754b based on the signal received from the at least one sensor such that the containers being transported are each filled with approximately the same volume, weight, or number of items.

In some embodiments, each processing line 707 further includes a support 790. The support 790 may be located adjacent to the right module 750b. In some embodiments, the support 790 is connected to the right module 750b. In some embodiments, the support 790 may be located adjacent to and connected to the left module 750a. The support 790 may extend along the length of the container fill conveyor 711 and is configured to support a lid portion of a container traveling on the container fill conveyor 711. In some embodiments, the support 790 does not initially contact the lid portion of the container. In some embodiments, a lid portion of a container only contacts the support 790 when items fall into the lid portion of the container from an item conveyor as described above, thereby causing the lid portion to dip down until it contacts the support 790. This configuration may be beneficial for supporting the lid portion of the container when too many items fall into the lid portion. Additionally, the support 790 may serve to prevent the container from falling off of the container fill conveyor 711 if the lid portion of the container becomes overfilled with items.

As seen in FIG. 9, in some embodiments, each processing lane 707 includes an overflow receiving container 780, such as a bin or other type of container. The overflow receiving container 780 may be positioned underneath the container fill conveyor 711 at a location near the container filling location 704, for example, to catch any items that do not fall into containers being transported by container fill conveyor 711 or that bounce or fall out of the containers. In some embodiments, the overflow receiving container 780 may be significantly larger than the containers being transported by the container fill container 711. In some embodiments, the overflow receiving container 780 is positioned beneath at least container fill conveyor 711 such that the overflow receiving containers 780 extends along the breadth and width of the container fill conveyor 711. Such a configuration may be beneficial for catching items that fall out of the containers being transported by the container fill conveyor 711.

As seen in FIGS. 8-11, the system 700 may include a first lateral movement device 730 and a second lateral movement device 740. The first lateral movement device 730 includes a knob 732, a screw 734 (as seen in FIGS. 8 and 10) and a plurality of actuators 736 (as seen in FIG. 11). Actuators 736 may be, for example, internally threaded nuts engaged with the exterior threads of the corresponding screw 734 and rotationally fixed to an associated module 750a or 750b. The knob 732 is connected to the screw on a first side of the system 700. The screw 734 extends from one side of the system 700 to the opposite side of the system 700 and passes through the left and right modules 750a and 750b of each processing lane 707. The plurality of actuators 736 can be disposed along the length of the screw 734. For example, each left module 750a of the processing lanes 707 may have two actuators each engaged with one of the screws 734, while each right module 750b may have apertures disposed such that the screws 734 pass through the apertures and can turn freely within the apertures without moving right module 750b. Alternatively, actuators 736 can be disposed on the right modules 750b, with the non-engaging apertures disposed in the left modules 750a.

Upon rotating the knob 732 in a first direction, the screw 734 rotates in the first direction and causes each pair of actuators 736 to be laterally translated along the length of the screw 734 in a first lateral direction. The actuators 736 are fixed to the left modules 750a, causing the left modules 750a to translate along the length of the screw 734 in the same direction as the actuators 736. Upon rotating the knob 732 in a second direction, the screw 734 rotates in the second direction and causes each pair of actuators 736 and the corresponding left module 750a to be laterally translated along the length of the screw 734 in a second lateral direction.

Similar to the first lateral movement device 730, the second lateral movement device 740 includes a knob 742, a screw 744 and a plurality of actuators. The knob 742 is connected to the screw 744 on a first side of the system 700. The screw 744 extends from one side of the system 700 to the opposite side of the system 700 and passes through the left and right modules 750a and 750b of each processing lane 707. The plurality of actuators is disposed along the length of the screw 744, a pair of actuators on each side of each right module 750b of the processing lanes 707.

This configuration of the first and second lateral movement devices 730 and 740 beneficially allows the system 700 to accommodate containers of different shapes and sizes. In some embodiments, a user may rotate the knobs 732 and 742 of the first and second lateral movement devices 730 and 740 simultaneously in a first direction (e.g., clockwise or counterclockwise) to create a larger gap in between the left and right modules 750a and 750b of each processing lane 707. This allows the system to accommodate a container of a larger size. Rotating the knobs 732 and 742 of the first and second lateral movement devices 730 and 740 in a second direction (e.g., counterclockwise or clockwise) moves the left modules 750a in the opposite direction to create a smaller gap in between the left and right modules 750a and 750b of each processing lane 707. This allows the system to accommodate a container of a smaller size.

The system 700 may include an overhead stop 720. The overhead stop 720 is located above the container fill conveyor 711. In some embodiments, the overhead stop 720 is located proximate the container filling location 704. The overhead stop 720 may be configured to serve as a stop for items traveling on an item conveyor such that there is a gap between the stop and item conveyor. The overhead stop 720 is configured to prevent items traveling on the item conveyor from falling on the container fill conveyor 711 at a location beyond the container filling location 704. This configuration is beneficial for ensuring that a substantial number of items traveling on the item conveyor fall into containers on the container fill conveyor 711 at the conveyor filling location 704.

In some embodiments, the system 100 further includes one or more guides 770. In some embodiments, the guides 770 are composed of a metal or polymer. In some embodiments, the guides 770 are composed of stainless steel. In some embodiments, the guides 770 are attached to the overhead stop and are positioned over the container filling location 704. The guides 770 are configured to direct items that fall off an item conveyor at the container filling location 704 into the containers being transported by the container fill conveyor 711. In some embodiments, the number of guides 770 may be equal to the number of processing lanes 707 of the container fill conveyor 711 (e.g., a guide 770 may be provided for each processing lane 707). Each guide 770 may be at least partially funnel-shaped, such that the distance between lower portions of the guides 770 is smaller than a width of the containers being filled. Such a configuration may be beneficial for reducing the number of items that fall outside the containers and into the overflow receiving containers 780.

### Item Processing Systems

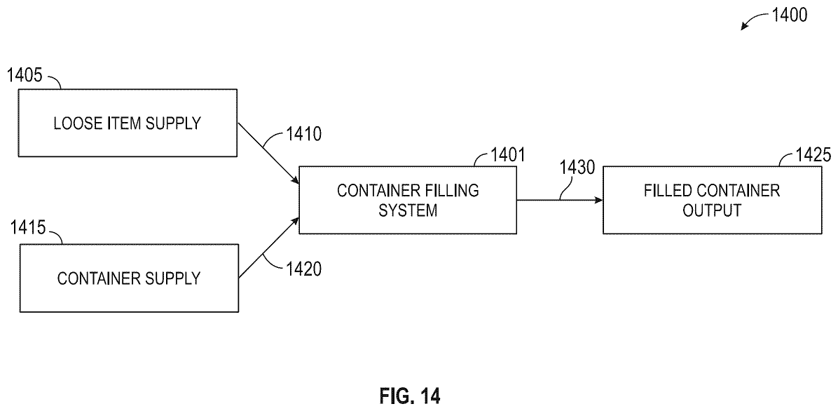

FIG. 14 is a schematic illustration of an example item processing system 1400 including a container filling system 1401 in accordance with the present disclosure. In various embodiments, the container filling system 1401 may be, for example, any one of the container filling systems 100, 700 or variants thereof as described herein. The item processing system 1400 further includes a loose item supply 1405, a container supply 1415, and a filled container output 1425. Loose items can be transported from the loose item supply 1405 to the container filling system 100, 700 by an item intake flow path 1410. Empty containers can be transported from the container supply 1415 to the container filling system 1401 by a container intake flow path 1420. After items are transferred into the containers at the container filling system 1401 the filled containers can be transported to the filled container output 1425 by a filled container output flow path 1430.

Each of the flow paths 1410, 1420, 1430 can be, for example, a conveyor or other transport mechanism, such as a conveyor belt surface, a series of rollers, any combination thereof, or any other conveying system configured to move items and/or containers laterally and/or vertically. In some embodiments, the item intake flow path 1410 may include a conveyor such as the item conveyor 101 described elsewhere herein. The container intake flow path 1420 may include a conveyor such as the container supply conveyor 110 described elsewhere herein. The filled container output flow path 1430 may be any suitable conveying mechanism such as a conveyor belt, a set of rollers, or the like.

In an example method of operation, the container filling system 1401 receives a continuous supply of items from the loose item supply 1405 via the item intake flow path 1410. The container filling system 1401 simultaneously receives a continuous supply of empty containers from the container supply 1415 via the container intake flow path 1420. At the container filling system 1401 the loose items are transferred into the empty containers to fill individual empty containers with a predetermined threshold number, weight, or volume of items. After the transfer, the filled containers travel to the filled container output 1425 via the filled container output flow path 1430. As filled containers leave the container filling system 1401 the example method can be repeated continuously with additional containers from the container supply 1415. This example method can be repeated any number of times or indefinitely as long as loose items and containers are received for filling.

### Further Implementations of Systems and Methods of the Present Disclosure

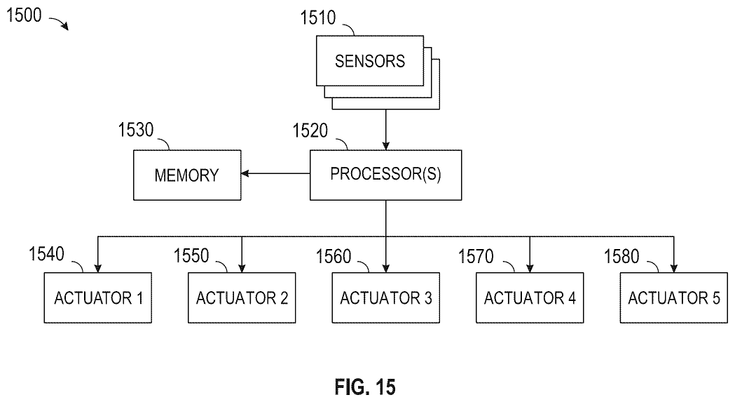

FIG. 15 is a block diagram of a container filling system 1500 in accordance with an example embodiment. The system 1500 includes one or more sensors 1510 in communication with one or more processors 1520. The processors 1520 are further in communication with a memory 1530 and actuators including actuator 1540, actuator 1550, actuator 1560, actuator 1570, and actuator 1580. Although the system 1500 is depicted as having 5 actuators, the number of actuators in various embodiments can be greater or smaller than 5, for example, based on the number of parts to be moved in any particular embodiment of the system 1500.

The system 1500 can include one or more sensors 1510 configured to determine a status of one or more components of the system 1500. For example, the sensors 1510 can include sensors configured to detect the items entering the container filling system 1500 (e.g., the sensors 102 as shown in FIGS. 1-6). The sensors 1510 may be optical sensors configured to detect the presence of an item along a beam path (e.g., a vertical beam path between a sensor 102 and the item conveyor 101) and to generate a signal indicating whether an item is or is not present below the sensor. In another example, the sensors 1510 can further include one or more position sensors configured to detect a number of accumulated containers along a container intake flow path (e.g., the container intake flow path 1420 of FIG. 14 and/or along the container supply conveyor 110 of FIGS. 1-6).

The one or more processors 1520 are configured to control and receive input from the sensors 1510, the memory 1530, and the actuators 1540, 1550, 1560, 1570, and 1580. The memory 1530 can store data received from the one or more processors 820 and send data stored therein to the one or more processors 1520. Examples of information that may be received and stored in the memory 1530 include, for example, information received at the one or more processors 1520 from the sensors 1510, information received at the one or more processors from the actuators 1540, 1550, 1560, 1570, and 1580, and one or more computer-executable instructions that, when executed by the one or more processors 1520, cause the one or more processors to selectively activate and/or deactivate the actuators 1540, 1550, 1560, 1570, and 1580 to control the filling of containers within the system 1500.

The actuators 1540, 1550, 1560, 1570, and 1580 can be electronically controllable actuators each coupled to and configured to control one or more mechanical components of the system 1500. Each actuator 1540, 1550, 1560, 1570, and 1580 can include one or more electric motors, hydraulic cylinders, pneumatic actuators, screw jacks, servos, solenoids, or the like. In one example implementation of the container filling system 100 depicted in FIGS. 1-6, the actuators may be arranged such that, for example, actuators 1540 and 1550 correspond to the motors 432 configured to control the speed of the container fill conveyors 111, actuator 1560 corresponds to a motor configured to control the item conveyor 101, and actuators 1570 and 1580 correspond to motors configured to control the container supply conveyors 110. In one example implementation of the container filling system 700 depicted in FIGS. 7-13, the actuators may be arranged such that, for example, actuators 1540 and 1550 correspond to the motor or motors 760 configured to control the speed of the container fill conveyor 711, actuator 1560 corresponds to a motor configured to control the item conveyor, and actuators 1570 and 1580 correspond to motors configured to control the container supply conveyors.

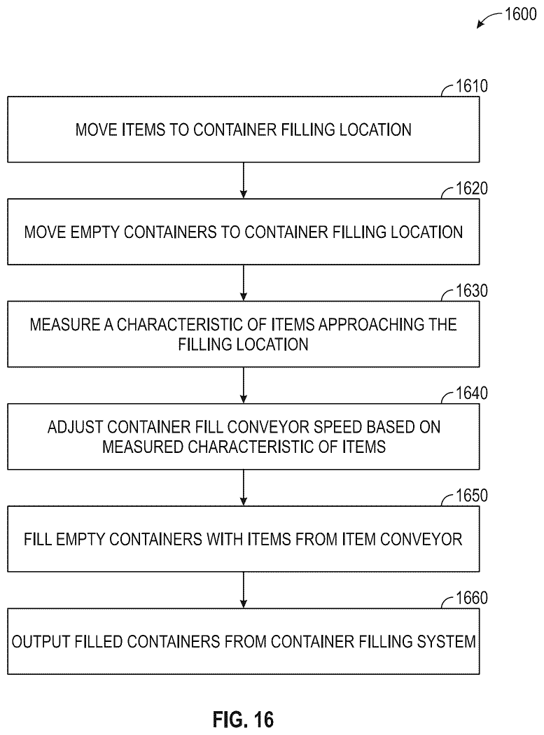

FIG. 16 is a flowchart illustrating an example method 1600 for filling containers using the systems disclosed herein. Throughout the description of FIG. 16, reference will also be made to components of the systems and processes of FIGS. 1-13. Although the method 1600 will be described with reference to components of the systems 100, 700, and 1400, the method 1600 can be performed by a computer integrated within any other suitable system for filling containers, for example, under control of one or more processors based on computer-executable instructions.

The method 1600 begins at block 1610, where items are moved by the item conveyor 101 to a container filling location 104 or 704. Upon arriving at the container filling location, the items may fall off an end of the item conveyor 101. In some embodiments, the item conveyor 101 may be controlled such as by a processor 1420 to move at a constant speed to deliver items toward the container filling location 104 or 704.

At block 1620, empty containers are transported by at least one container conveyor 103 from a location upstream to the container filling location 104 or 704. In some embodiments, the at least one container conveyor 103 may include a container supply conveyor 110 and a container fill conveyor 111 or 711. In some embodiments, the container supply conveyor 110 may be controlled such as by a processor 1420 to move at a constant speed to deliver containers to the container fill conveyor 111 or 711. The container fill conveyor 111 or 711 may be controlled such as by the same or a different processor 1420 to induct containers from the container supply conveyor 110 into the container fill conveyor 111 or 711 and to move the inducted empty containers at a constant or variable speed to the container filling location 104 or 704.

At block 1630, as the items approach the container filling location, a characteristic of the items being transported by the item conveyor 101 may be measured by at least one sensor 102 positioned above the item conveyor 101. In some embodiments, the characteristic measured by the at least one sensor 102 may be a volume flux of the items being transported on the item conveyor 101. For example, measuring a characteristic of the items being transported by the item conveyor 101 may include projecting a plurality of light beams from the sensors 102 toward the item conveyor and detecting when the items break or interrupt the beams being projected onto the item conveyor 101.

In some embodiments, such as where an array of sensors 102 are located along the width of the item conveyor 101 or a portion of the item conveyor (e.g., within a processing lane 107), the signals received at the one or more processors 1420 can be individual periodic signals from each sensor 102 indicating whether the corresponding beam is broken or is hitting the item conveyor 101. Based on the signals, the one or more processors 1420 can determine a volume flux of items approaching the item filling location 104. In some embodiments, the volume flux can be a calculated quantity in terms of a volume measure per unit time, determined based at least in part on a known speed of the item conveyor 101, an estimated shape profile of the items (e.g., a shape of a strawberry or other produce item), and/or the relative amounts of time that the sensors are blocked and unblocked by items traveling on the item conveyor 101. Alternatively, the volume flux can be a unitless quantity calculated as a mathematical function of the binary on/off signals received at a repeating periodic interval from the sensors 102.

At block 1640, a speed of the container conveyor 103 is adjusted by the one or more processors 1420, based on the measured characteristic. In some embodiments, the measured characteristic may be a volume flux of the items being transported by the item conveyor 101 within a single item processing lane 107. For example, the speed of the container fill conveyor 111 or 711 may be adjusted based on the calculated volume flux such that the containers being transported by the container fill conveyor 111 or 711 are filled with approximately the same number or volume of items falling off of the end of the item conveyor 101. In one particular example, the volume flux may be calculated and updated in real time or substantially real time as items continuously arrive on the item conveyor 101. Each time an updated volume flux is calculated, the updated volume flux may be provided as an input to a motor control algorithm executed by the one or more processors 1420. Continued and/or repeated execution of the motor control algorithm causes the one or more processors 1420 to control the operating speed of the corresponding motor 432 or 760 (and thereby to control the speed of the corresponding belt 112, side belts 752a or 752b, or bottom belts 754a or 754b) as a function of the continually updated volume flux of arriving items. For example, a relatively lower volume flux may cause the one or more processors 1420 to decrease the speed of the motor 432 or 760 and a relatively higher volume flux may cause the one or more processors 1420 to increase the speed of the motor 432 or 760.

At block 1650, the empty containers being transported by the container fill conveyor 111 or 711 may be filled by the items falling off the end of the item conveyor 101 at the container filling location 104 or 704. In some embodiments, the empty containers are each filled with approximately the same number or volume of items.

At block 1660, the filled containers are transported by the at least one container conveyor 103 from the container filling location 104 or 704 to a location downstream within the processing line. In some embodiments, the filled containers are transported by the container fill conveyor 111 or 711 from the container fill location 104 or 704 to a location further down the processing line. The method 1600 can continue indefinitely as additional items 101 and containers are received for filling.

### Implementing Systems and Terminology

Implementations disclosed herein provide systems, methods, and devices for transferring items from bins or other containers. It will be appreciated that the systems and methods described herein are not limited to the context of packing strawberries or other fruit. Rather, the systems and methods described herein may be used for a wide variety of implementations. One skilled in the art will recognize that these embodiments may be implemented in hardware or a combination of hardware and software and/or firmware.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The foregoing description details certain embodiments of the systems, devices, and methods disclosed herein. It will be appreciated, however, that no matter how detailed the foregoing appears in text, the systems, devices, and methods can be practiced in many ways. It should be noted that the use of particular terminology when describing certain features or aspects of the present disclosure should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

The methods disclosed herein include one or more steps or actions for achieving the described methods. The method steps and/or actions may be interchanged with one another without departing from the scope of the present disclosure. In other words, unless a specific order of steps or actions is required for proper operation of the method that is being described, the order and/or use of specific steps and/or actions may be modified without departing from the scope of the present disclosure.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). Further, the term “comprising” as used herein is synonymous with “including,” “containing,” or “characterized by,” and is inclusive or open-ended and does not exclude additional, unrecited elements or method steps. Accordingly, the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is noted that some examples above may be described as a process, which is depicted as a flowchart, a flow diagram, a structure diagram, or a block diagram. Although a flowchart may describe the operations as a sequential process, many of the operations can be performed in parallel, or concurrently, and the process can be repeated. In addition, the order of the operations may be rearranged. A process is terminated when its operations are completed. A process may correspond to a method, a function, a procedure, a subroutine, a subprogram, etc. When a process corresponds to a software function, its termination corresponds to a return of the function to the calling function or the main function.

1. A system comprising:
a container conveyor configured to move containers to a container filling location;
an item conveyor configured to move items to the container filling location, the item conveyor having a downstream end disposed above the container conveyor at the container filling location;
one or more sensors configured to detect the items moving on the item conveyor; and
one or more processors in communication with the container conveyor and the one or more sensors, the one or more processors configured with computer-executable instructions to at least:
receive signals from the one or more sensors; and
control a speed of the container conveyor based on the signals received from the one or more sensors.

2. The system of claim 1, wherein the container conveyor comprises a container supply conveyor and a container fill conveyor.

3. The system of claim 2, wherein the container fill conveyor receives the containers from the container supply conveyor and moves the containers to the container filling location.

4. The system of claim 3, wherein the container fill conveyor comprises one or more drive belts configured to grip the containers received from the container supply conveyor.

5. The system of claim 2, wherein the container supply conveyor carries containers from an upstream location to the container fill conveyor.

6. The system of claim 5, wherein the container supply conveyor continuously carries containers to the container fill conveyor such that the containers accumulate at a location proximate the container fill conveyor.

7. The system of claim 2, wherein the speed controlled by the one or more processors is a speed of the container fill conveyor.

8. The system of claim 7, wherein the one or more processors are further configured to maintain a speed of the container supply conveyor constant while adjusting the speed of the container fill conveyor.

9. The system of claim 1, wherein the container conveyor comprises at least two side belts configured to laterally grip the containers on opposing sides of the container.

10. The system of claim 9, wherein each of the at least two side belts is configured to move at a same speed.

11. The system of claim 9, wherein the container conveyor further comprises at least one bottom belt configured to contact bottom sides of the containers.

12. The system of claim 11, wherein each of the at least one bottom belt is configured to move at the same speed as the at least two side belts.

13. The system of claim 9, wherein the container conveyor comprises a left module including a first one of the at least two side belts and a right module including a second one of the at least two side belts.

14. The system of claim 13, further comprising at least one lateral movement device, the lateral movement device configured to adjust a distance between the left module and the right module.

15. The system of claim 1, wherein the one or more processors are further configured to determine, based on the received signals from the one or more sensors, a volume flux of items moving on the item conveyor.

16. The system of claim 15, wherein the one or more processors are further configured to calculate an updated volume flux based on the received signals from the one or more sensors.

17. The system of claim 16, wherein the one or more processors are further configured to increase the speed of the container conveyor in response to an increase in the updated volume flux and to decrease the speed of the container conveyor in response to a decrease in the updated volume flux.

18. The system of claim 1, wherein the item conveyor is disposed such that the items fall off the downstream end of the item conveyor upon arriving at the container filling location.

19. The system of claim 1, further comprising a guide at the container filling location, the guide comprising at least one wall positioned to guide the items falling from the downstream end of the item conveyor into the containers on the container conveyor.

20. The system of claim 1, wherein the one or more processors are configured to control the speed of the container conveyor such that each of the containers are filled with a predetermined volume of items.

21. The system of claim 1, wherein the one or more sensors comprises at least one optical sensor, at least one two dimensional camera, or at least one three dimensional camera.

22. The system of claim 1, wherein the items are strawberries.

23-29. (canceled)
